(19) United States
(12) Patent Application Publication
(10) Pub. No.: US 2019/0023336 A1
(43) Pub. Date: Jan. 24, 2019

(54) Spark Emitting Motorcycle Wheelie Bar

(71) Applicant: Joseph Reuban Wermer, Los Alamos, NM (US)

(72) Inventor: Joseph Reuban Wermer, Los Alamos, NM (US)

(21) Appl. No.: 15/653,940

(22) Filed: Jul. 19, 2017

(51) Int. Cl. B62D 61/12; B60R 99/00

(52) U.S. Cl. CPC B62D 61/12; B60R 99/00

(57) ABSTRACT

The present invention is a system to extend the tail of a motorcycle so that a piece of spark emitting material such as titanium is located at the furthermost rear of the vehicle. The purpose of this invention is to create sparks when the motorcycle is being operated on the rear wheel and the extension makes contact with an abrasive surface such as asphalt. The piece of spark emitting material is attached to the extension in a cavity and is held in place by the clamp pressure between the cavity walls. This allows for quick replacement of the spark emitting as well as effective distribution of sparks when contact is made with an abrasive surface.

### FIELD OF INVENTION

The present invention is a system for creating sparks when a motorcycle or similar vehicle is being driven on the rear wheel. The invention is a system for extending tail the tail of the vehicle so that a piece of spark emitting material attaches to the rear of the vehicle. When the vehicle is driven on the rear wheel, sparks are created as the extension makes contact with an abrasive surface such as the road.

### DESCRIPTION OF PRIOR ART

U.S. Pat. No. 8,408,911 relates to the use of the apparatus for safely training a motorcycle rider to perform a wheelie, either while moving or while stationary. The apparatus provides a safety system, which prevents the motorcycle from tipping over backwards or sideways. The prior art attaches to the rear wheel and axle instead of the tail of the vehicle where the present invention attaches. The prior art does not provide a method for creating sparks while performing a wheelie.

U.S. Pat. No. 7,578,721 relates to the use wheelie bars used in model vehicles. The prior art utilizes wheels on the end of the wheelie bar so that the vehicle can remain stable while performing wheelies. The prior art does not provide a method for creating sparks while performing a wheelie as the present invention does.

U.S. Pat. No. 6,149,179 relates to the use of an extension to assist in stabilizing a bicycle traveling on the rear wheel. The prior art is a safety device for individuals learning how to travel on the rear wheel of a bicycle. The prior art does not provide a method for creating sparks while performing a wheelie as the present invention does. The prior art attaches the rear axle and uses wheels to spin on the ground where the present invention attaches the tail of the vehicle and uses a spark emitting insert.

U.S. Pat. No. 5,330,221 relates to the use a learning device for users learning to ride a bicycle on the rear wheel. The device attaches the rear axle and frame of the bicycle and uses wheels to roll on the ground during a wheelie. The prior art does not provide a method for creating sparks while performing a wheelie as the present invention does.

U.S. Pat. No. D394,033 relates to the use of a bracket to brace a wheelie bar to the rear wheel of a vehicle. The prior art does not provide a method for creating sparks while performing a wheelie as the present invention does.

### SUMMARY OF THE INVENTION

The present invention is a system for extending the tail of a motorcycle so that a section of spark emitting material such as titanium is located the very rear of the motorcycle. The spark emitting material is located in a cavity on the extension and held in place by clamp pressure between the cavity walls.

Benefits of the current invention include quick replacement of spark emitting inserts, cheap production of inserts, and damage prevention to vehicle.

It is therefore a primary object of the present invention to provide a highly effective method for attaching titanium or other spark emitting material to the rear of a motorcycle to create sparks when the operator rides the motorcycle only on the rear wheel.

It is another object of the present invention to prevent damage to the operator and vehicle while performing wheelies.

### BRIEF DESCRIPTION OF DRAWING

FIG. 1 displays where the present invention (1) is located on the vehicle (7). The present invention (1) is securely attached to the tail or sub frame (5) of the vehicle (7).

FIG. 2 displays a top view of the present invention (1) where the insert (2) is located in the cavity (3) and is held in place by clamp pressure that may be generated by cross bolts (4). The present invention is securely attached to the sub frame (5).

FIG. 3 displays a side view of the present invention (1) where the insert (2) fits into the cavity (3) and is held in place by tightening the cross bolts (4). The present invention (1) is securely attached to the sub frame (5) of the vehicle (7).

### DETAILED DESCRIPTION OF THE INVENTION

1. Definitions

Body; Section of material attached to the rear sub frame of a motorcycle of which a piece of spark emitting material is attached to.

Insert; Piece of spark emitting material attached to the body

Spark emitting material; Any material that emits sparks when contact is made with an abrasive surface such as asphalt.

Wheelie; A trick performed on a vehicle where the vehicle is traveling only on the rear wheel(s).

2. Best Mode of Invention

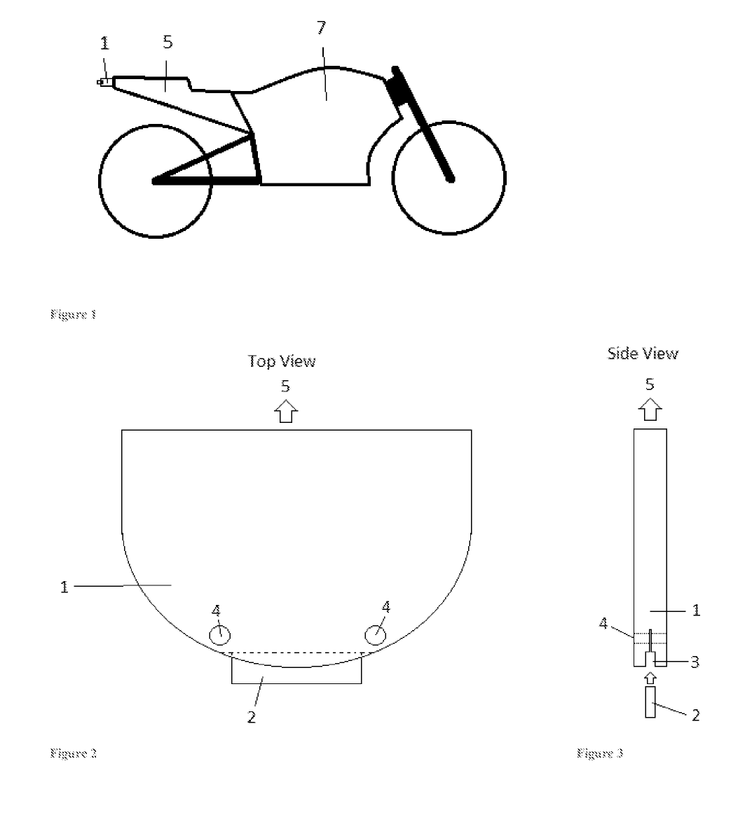

The best mode of the invention as shown in FIGS. 1 and 2 is a system for attaching a piece of spark emitting material to the rear sub frame of a motorcycle so that in the event the operator balances the motorcycle on the rear wheel, sparks are created in the process.

This extension consists of two major pieces, a body that attaches directly to the rear sub frame of the motorcycle and an insert that fits into a cavity onto the body.

3. How to Make the Invention

The body of the extension is to be machined or fabricated from a strong material such as aluminum. A cavity is to be machined or fabricated on the end of the extension to adapt to the insert of a spark emitting material. The cavity must be made in a way that allows to body to flex when pressure is applied so that the cavity size is decreased. The spark emitting material is to be machined or fabricated in a way that allows the insert to fit inside of the cavity on the body so that when clamp pressure is applied the insert is held securely in place.

### Benefits for the Current Invention

An effective method for attaching a spark emitting material to the rear sub frame of a motorcycle.

Effortless and quick replacement of spark emitting inserts.

Low cost production of spark emitting inserts.

Effective distribution of sparks emitted when contact is made with an abrasive surface.

1. A system for creating sparks when a motorcycle is traveling on the rear wheel wherein a piece of spark emitting material which is located on the rear of the motorcycle makes contact with an abrasive surface wherein the spark emitting material is held in place in a cavity located on the rear of the vehicle.

2. A system according to claim 1 wherein a body composed of a strong material such as aluminum is securely attached to the rear sub frame or tail of a motorcycle or similar vehicle.

3. A system according to claim 1 wherein an insert composed of a spark emitting material such as titanium is located inside a cavity on the body of material.

4. A system according to claim 1 wherein the size of the insert is less than or equal to the size of the cavity on the body.

5. A system according to claim 1 wherein the insert of spark emitting material is held in place by being clamped between the surfaces inside of the cavity.

6. A system according to claim 1 wherein the clamp pressure is generated by applying pressure to the outside of the cavity so that the size of the cavity is reduced holding the insert securely in place.

7. A system according to claim 1 wherein the clamp pressure may be generated by using cross bolts going through the body of the assembly traveling perpendicular to the cavity.

8. A system according to claim 1 wherein the insert can be replaced by releasing the clamp pressure, removing the old insert, replacing with a new insert, and reapplying the clamp pressure.

9. A system according to claim 1 wherein the insert is extendable once worn down.

10. A system according to claim 1 wherein the spark emitting material is chemically treated to produce different colored sparks.

11. A system according to claim 1 wherein the shape of the cavity and insert is not limited to a rectangular shape.

12. A system according to claim 1 wherein the cavity may extend through the body to allow room for the insert to extend.

13. A system according to claim 1 wherein the vehicle is not limited to motorcycles.
